(19) United States
(12) Patent Application Publication
(10) Pub. No.: US 2013/0120250 A1
(43) Pub. Date: May 16, 2013

(54) GESTURE RECOGNITION SYSTEM AND METHOD

(71) Applicants: Jyun-cheng LIN, Zhongli City (TW); Chih-yin CHIANG, Nantou City (TW); Ru-ji HSIEH, Luzhu Township (TW)

(72) Inventors: Jyun-cheng LIN, Zhongli City (TW); Chih-yin CHIANG, Nantou City (TW); Ru-ji HSIEH, Luzhu Township (TW)

(73) Assignee: CHUNGHWA PICTURE TUBES, LTD., Bade City (TW)

(21) Appl. No.: 13/366,323

(22) Filed: Feb. 5, 2012

(30) Foreign Application Priority Data
Nov. 16, 2011 (TW) 100141863

(51) Int. Cl. G06F 3/033

(52) U.S. Cl. 345/157

(57) ABSTRACT

The present invention provides a gesture recognition system and method which utilizes an open gesture and a close gesture made by a user's hand in simulating a releasing operation and a pressing operation of a mouse. In the present invention, the coordinate of the user's hand is unlikely to shift or change when simulating a mouse click. The present invention can solve the problem of the hand coordinate that is shift when simulating the mouse click in convention skills.

### TECHNICAL FIELD OF THE INVENTION

The present invention relates to a gesture recognition system and method, and more particularly, to a gesture recognition system and method, in which a click operation is simulated by a user's hand gesture.

### BACKGROUND OF THE INVENTION

FIG. 1 is a schematic diagram showing a hardware arrangement of a conventional gesture recognition system. As shown in FIG. 1, by a driver, a motion sensing input device (e.g., Kinect) 12 is communicated with an operating system (e.g., Windows) installed in a host computer 14. The host computer 14 is coupled to a display 16. Gestures made by a user's hand in the front of the motion sensing input device 12 can be recognized as a simulation of a mouse's operations and thereby the user can operate the host computer 14 through the display 16.

For Kinect machines, Microsoft Corporation utilizes an open natural interaction (OpenNI) framework which provides an application programming interface (API) for writing applications utilizing natural interaction, and provides a multi-language, cross-platform standard interface such that it is more convenient for developers to use visual or sound sensors and analyze data by using a middleware.

When utilizing the Kinect machines to recognize hand gestures, a middleware called “NITE” can be used to track the motion of hand so as to obtain hand coordinates. The hand coordinates are mapped to the positions of a mouse cursor in the operating system such that can simulate the mouse movement can be simulated by the user's hand motion. It also can utilize a motion instruction set provided by the OpenNI framework to simulate a hand gesture as a click event of the mouse.

However, in conventional skills, a pressing operation and a releasing operation of the mouse are simulated by gestures that are made when the user pushes his/her hand ahead and retracts backward the hand. This easily causes a shift of the hand coordinate when simulating a double click of the mouse. This is because the user's hand has to quickly move forward and retract backward for twice. The motion of the user's elbow will change the hand coordinate. It is quite inconvenient for the user when utilizing the aforesaid approach and the accuracy of click performance is bad.

Therefore, it is necessary to develop a gesture recognition system and method for improving the click accuracy when simulating a mouse click.

### SUMMARY OF THE INVENTION

An objective of the present invention is to provide a gesture recognition system and method for solving the problem of a hand coordinate that is shifting when simulating a mouse click.

To achieve the above objective, the present invention provides a gesture recognition method, for recognizing a hand gesture made by a user in the front of an electronic device to simulate an operation of a mouse, the method comprising steps of: capturing an image including the user; determining a hand coordinate of the user; processing the image including the user to obtain a hand image of the user's hand; calculating a point coordinate of a point, which belongs to the user's hand in the hand image and is located farthest from the hand coordinate; and simulating a click event of the mouse according to a distance between the point coordinate and the hand coordinate.

Another aspect of the present invention provides a gesture recognition method, for recognizing a hand gesture made by a user in the front of an electronic device to simulate an operation of a mouse, the method comprising steps of: capturing an image including the user; determining a hand coordinate of the user; processing the image including the user to obtain a hand image of the user's hand; determining a minimal circle that encloses a hand object in the hand image and obtaining a parameter for describing the minimal circle; and simulating a click event of the mouse according to the parameter describing the minimal circle.

Still another aspect of the present invention provides a gesture recognition system, which is coupled to an electronic device, for recognizing a hand gesture made by a user in the front of the electronic device to simulate an operation of a mouse, the system comprising: an image capturing module, for capturing an image including the user; a hand tracking module, for determining a hand coordinate of the user by computing image changes occurred when the user moves his/her hand; a hand image processing module receiving the image including the user captured by the image capturing module, for processing the image including the user to obtain a hand image of the user's hand; a hand feature extracting module receiving the hand image from the hand image processing module, for obtaining a parameter related to describe contours of a hand object in the hand image; and a gesture recognition module, for simulating a click event of the mouse according to a variation of the parameter.

In conventional skills, a pressing operation and a releasing operation of the mouse are simulated by gestures that are made when a user pushes his/her hand ahead and retracts backward the hand. This easily causes a shift of the hand coordinate. The present invention utilizes an open gesture and a close gesture made by the user's hand to simulate the pressing operation and the releasing operation of the mouse. In the present invention, the hand coordinate is more unlikely to shift or change when simulating a mouse click, especially a double click. Therefore, the present invention can solve the problem of a hand coordinate that is shifting when simulating the mouse click in the conventional skills.

### BRIEF DESCRIPTION OF THE DRAWINGS

FIG. 1 is a schematic diagram showing a hardware arrangement of a conventional gesture recognition system.

FIG. 2 is a schematic block diagram showing a gesture recognition system implemented according to the present invention.

FIG. 3 is a flow chart showing a gesture recognition method implemented according to a first embodiment of the present invention.

FIG. 4A is a schematic diagram showing that a user's hand is in an open gesture.

FIG. 4B is a schematic diagram showing that a user's hand is in a close gesture.

FIG. 5 is a flow chart showing specific work processes corresponding to the first embodiment of the present invention.

FIG. 6 is a flow chart showing a gesture recognition method implemented according to a second embodiment of the present invention.

FIG. 7A is a schematic diagram showing that a user's hand is in an open gesture.

FIG. 7B is a schematic diagram showing that a user's hand is in a close gesture.

FIG. 8 is a flow chart showing specific work processes corresponding to the second embodiment of the present invention.

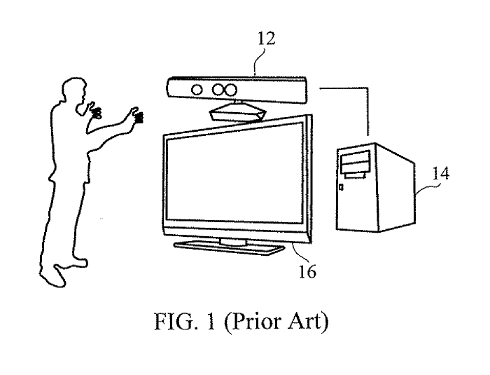

### DETAILED DESCRIPTION OF THE INVENTION

The present invention relates to a gesture recognition system and method. After obtaining a hand image of a user, the present invention can simulate a mouse operation by recognizing a hand gesture of the user. For example, a button pressing operation of a mouse can be simulated by a close gesture made by the user's hand, and a button releasing operation of the mouse can be simulated by an open gesture made by the user's hand. It can represent a click event of the mouse when the user's hand opens and then closes in order.

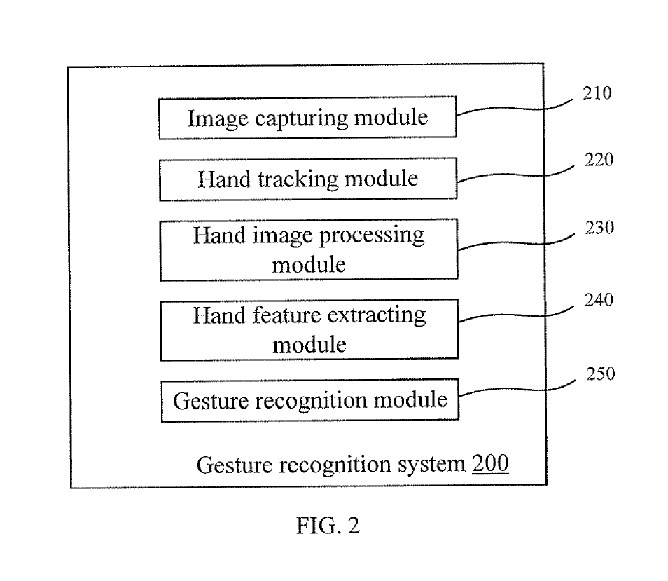

FIG. 2 is a schematic block diagram showing a gesture recognition system implemented according to the present invention. The gesture recognition system 200 of the present invention comprises an image capturing module 210, a hand tracking module 220, a hand image processing module 230, a hand feature extracting module 240, and a gesture recognition module 250. The gesture recognition system 200 can be coupled to an electronic device such as a display. The gesture recognition system 200 can be implemented by software, firmware, hardware, or their combinations. For example, the gesture recognition system 200 is installed in a computer system. The computer system is coupled to the display. Gestures made by a user in the front of the display can be recognized by the gesture recognition system 200 for simulating the mouse click event so as to operate the computer system.

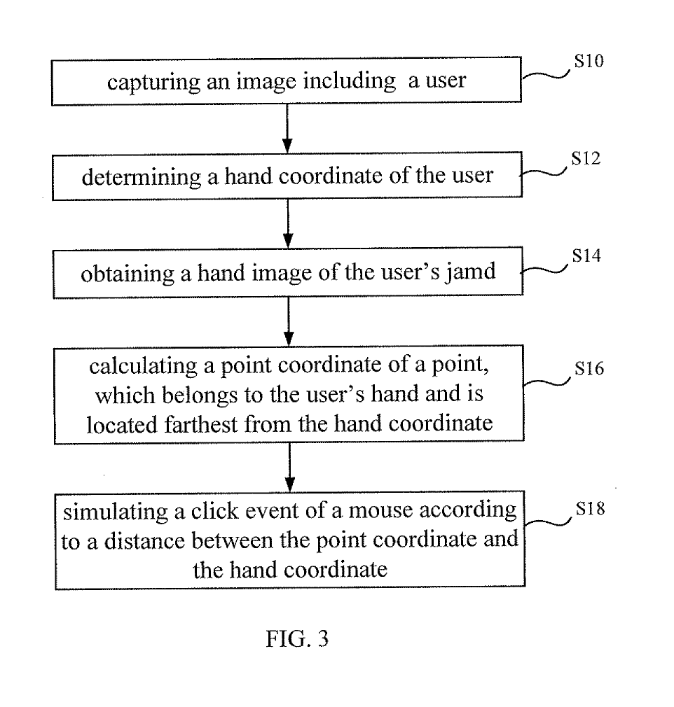

FIG. 3 is a flow chart showing a gesture recognition method implemented according to a first embodiment of the present invention. Referring to FIG. 2 and FIG. 3, the gesture recognition system and method of the present invention will be described below.

STEP S10: An image including a user is captured. When the gesture recognition system 200 is activated and the image capturing module 210 is launched, the image capturing module 210 will start to take a 3D image including a depth map. Meanwhile, the user and a background where the user is located are photographed.

STEP S12: A hand coordinate of the user is determined. The hand tracking module 220 will continuously track a moving object and determine the coordinate of the moving object. When the user waves or extends out his/her hand, the hand tracking module 220 can determine the coordinate of the user's hand by computing changes or variations of the images captured by the image capturing module 210 in STEP S10 or computing the difference between two adjacent images. For example, the hand coordinate corresponds to the position of a mouse cursor in the computer system, and therefore the motion of the cursor can be simulated by the position changes of the user's hand.

STEP S14: The hand image processing module 230 receives the image captured by the image capturing module 210 in STEP S10 and processes the image captured by the image capturing module 210 to obtain a hand image of the user's hand. The image captured by the image capturing module 210 contains not only the hand's hand but also other portions of the user's body, and contains the background as well. These portions will interfere with successive recognition thereafter. Therefore, these portions will be removed in this step and only the image of the user's hand is remained. Firstly, the user is asked to stand in a position distanced about 1.5 m from the image capturing module 210, and extend out the hand. Then, the image capturing module 210 takes a 3D image. The hand image processing module 230 will remove a part of the image captured by the capturing module 210, of which a depth value of the depth map is greater than a predetermined number (e.g., 1.2 m), to obtain a remaining image. In this manner, image sections of the background, the user's main body, and parts of an arm and elbow are removed. After afore-mentioned procedures, The remaining image may still remain some parts of forearm but these can be removed in subsequent procedures. The hand coordinate determined by the hand tracking module 220 in STEP S12 is taken as a center. Then, the hand image processing module 230 defines a predetermined region (e.g., a size of 140×140 pixels) on a basis of the center by processing the remaining image. The pixels outside the predetermined region are filled with a constant color value (e.g., 255, black). In this manner, a clear hand image is obtained. It is noted that the afore-mentioned remaining image and the extended predetermined region is obtained under a situation of not changing the size of the image captured by the image capturing module 210 and the positions of the pixels of the image.

STEP S16: The hand feature extracting module 240 receives the hand image from the hand image processing module 230 in STEP S14, and obtains a parameter related to describe contours of a hand object in the hand image. As described above, the present invention is to simulate the mouse operation according to the open gesture and the close gesture of the user's hand. In this step, whether the user's hand is in a close or open gesture can be determined by resolving contour variations of the hand object in the hand image. The area occupied by the hand object in the hand image is small if the user's hand is in a close gesture; the area occupied by the hand object in the hand image is large if the user's hand is in an open gesture. The area of the hand object of the hand image can be estimated quantitatively by using the parameter describing the contours of the hand object. In this embodiment, the hand feature extracting module 240 calculates a point coordinate of a point, which belongs to a portion of the user's hand in the hand image and is located farthest from the hand coordinate, for serving as a point representing the contours of the hand object. The distance between the point coordinate and the hand coordinate can represent the contour size of the hand object. The detailed explanations will be described later. In one embodiment, the hand feature extracting module 240 compare all the color values of pixels in the hand image with a threshold so as to determine which one of the pixels belongs to the hand object. Then, the hand feature extracting module 240 calculates the distances between the hand coordinate and the coordinates of these pixels, respectively. By iterative procedures, only the pixel located farther from the hand coordinate is remained. In another embodiment, the hand feature extracting module 240 can extract the pixels located at the contours of the hand object, and only calculate the distances between the hand coordinate and the coordinates of the pixels located at the contours of the hand object.

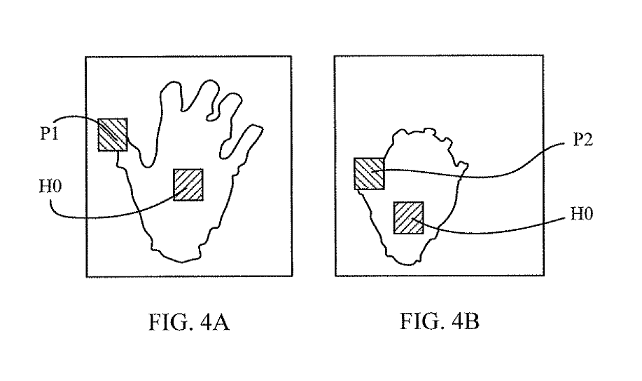

STEP S18: The gesture recognition module 250 calculates the distance between the hand coordinate and the point coordinate obtained by the hand feature extracting module 240 in STEP S16. The gesture recognition module 250 also can directly receive the distance of the hand coordinate and the point coordinate from the hand feature extracting module 240. The gesture recognition module 250 compares the distance between the hand coordinate and the point coordinate with a threshold. When the distance between the hand coordinate and the point coordinate is greater than the threshold, this means that the user's hand is in an open gesture and this can represent a releasing operation of the mouse. When the distance between the hand coordinate and the point coordinate is smaller than the threshold, this means that the user's hand is in a close gesture and this can represent a pressing operation of the mouse. In another embodiment, the gesture recognition module 250 also can simulate the operation of the mouse by determining a variation of the distance between the hand coordinate and the point coordinate. For example, when a variation of the distance between the hand coordinate and the point coordinate is greater than a positive threshold, this means that the user's hand is changed from a close gesture to an open gesture and this can represent the releasing operation of the mouser. When the variation of the distance between the hand coordinate and the point coordinate is smaller than a negative threshold, this means that the user's hand is changed from the open gesture to the close gesture and this can represent the pressing operation of the mouser. When the user's hand is changed from the open gesture to the close gesture and then opens again, this can represent a click event of the mouse. As shown in FIG. 4A and FIG. 4B, the point coordinates located farthest from the hand coordinate are represented by P1 and P2 when the user's hand is respectively in an open gesture and a close gesture. The distance between the point coordinate P1 and the hand coordinate HO is greater than the distance between the point coordinate P2 and the hand coordinate HO. That is, this can be utilized to represent the contour changes of the user's hand.

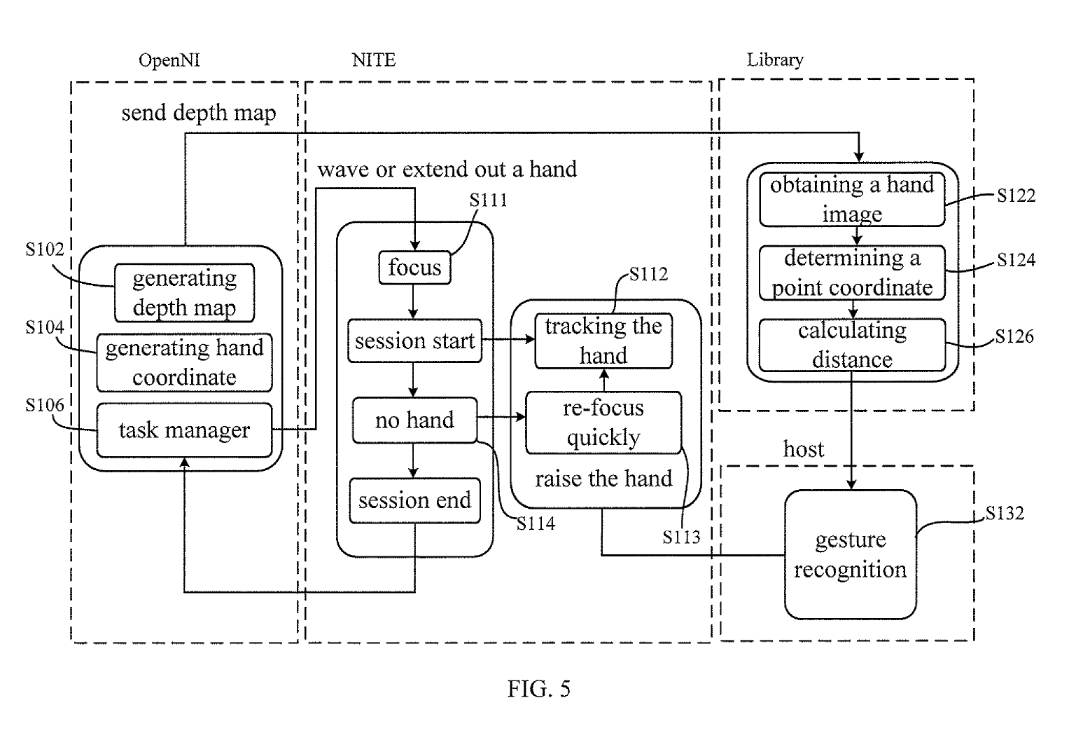

FIG. 5 is a flow chart showing specific work processes corresponding to the first embodiment of the present invention. The aforesaid modules in the gesture recognition system 200 of the present invention can be implemented by software installed in a computer system. A host of the computer system is coupled to a display and a motion sensing input device (e.g., “Kinect” produced by Microsoft Corporation). Gestures made by a user in front of the motion sensing input device can be recognized by the gesture recognition system 200. The gestures can be simulated as mouse operations such that the user can operate the computer system via the display. Firstly, a Kinect driver provided by Microsoft Corporation is installed in the host. The framework is mainly divided into four parts, e.g., open natural interaction (OpenNI) defined by Microsoft Corporation, a middleware, a library, and a self-developed application. It can utilize some programs provided by OpenNI to obtain images that are taken by a camera of Kinect, and depth maps thereof (STEP S102). One API of “NITE” which is a middleware to OpenNI can track the user's hand such that OpenNI can generate a hand coordinate (STEP S104). A session manager provided in OpenNI will manage hand tracking tasks for NITE (STEP S106). When the user waves or extends out his/her hand, NITE will control the camera to focus the hand (STEP S111) and start the tracking tasks. Once the user's hand is tracked (STEP S112), the hand coordinate (including a Z-directional axis) is soon generated and the hand coordinate is mapped to a coordinate of a mouse cursor. If the user's hand is out of a detecting range (STEP S114), the tracking is suspended or ended. When the user raises his/her hand again and the hand falls in the detecting range, NITE will control the camera to quickly focus the hand (STEP S113), and continues the tracking tasks.

The self-developed application installed in the host can utilize those functions provided in the library to perform an image processing to the image captured by the camera so as to obtain a hand image (STEP S122). For example, a part of the captured image of which a depth value of the depth map is greater than a predetermined distance is removed so as to obtain a remaining image, and then a predetermined region is defined on a basis of the hand coordinate by processing the remaining image so as to obtain a clear hand image. In STEP S124, it can utilize the functions provided in the library or a self-developed function to calculate a point coordinate of a point, which belongs to a hand object in the hand image and is located farthest from the hand coordinate, for serving as a point representing contours of the hand object. Next, it can utilize the functions provided in the library to calculate the distance between the hand coordinate and the point coordinate or directly calculate the distance (STEP S126). The distance between the hand coordinate and the point coordinate can represent the contour size of the hand object. By determining the distance between the hand coordinate and the point coordinate or a variation of the distance therebetween, the self-developed application in the host can determine whether the user's hand is in an open gesture or a close gesture such that a click event of the mouse can be simulated (STEP S132).

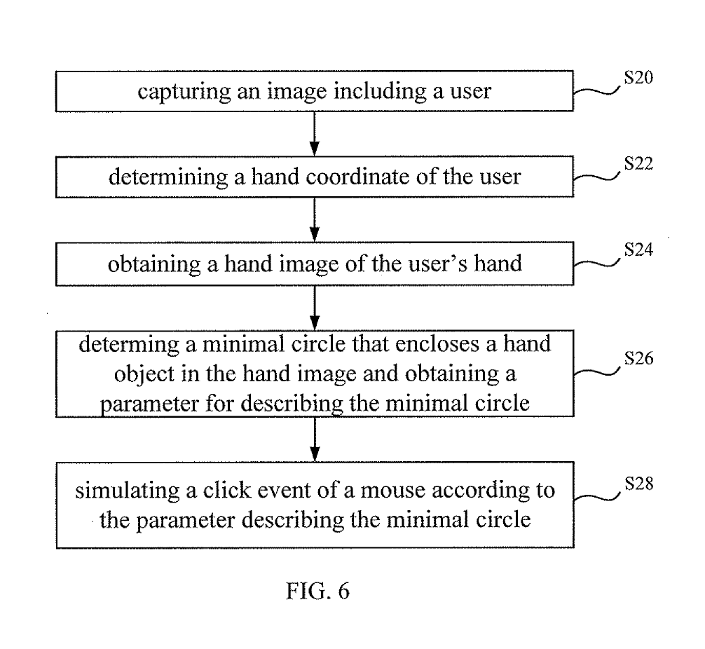

FIG. 6 is a flow chart showing a gesture recognition method implemented according to a second embodiment of the present invention. Referring to FIG. 2 and FIG. 6, STEP S20, STEP S22, and STEP S24 in the gesture recognition method of the second embodiment of the present invention are respectively similar to STEP S10, STEP S12, and STEP S14 in the first embodiment. The descriptions of these steps are omitted herein for simplicity and clarity. STEP S26 and STEP S28 in the gesture recognition method of the second embodiment of the present invention will be described below.

STEP S26: The hand feature extracting module 240 receives the hand image from the hand image processing module 230 in STEP S24, and obtains a parameter related to describe contours of a hand object in the hand image. As described above, the present invention is to simulate the mouse operation according to the open gesture and the close gesture of the user's hand. In this step, whether the user's hand is in a close gesture or an open gesture can be determined by resolving contour variations of the hand object in the hand image. The area occupied by the hand object in the hand image is small if the user's hand is in the close gesture; the area occupied by the hand object in the hand image is large if the user's hand is open. The area of the hand object of the hand image can be estimated quantitatively by using the parameter describing the contours of the hand object. In this embodiment, the hand feature extracting module 240 extracts points that belong to the contours of the hand object in the hand image, and then determines a minimal circle enclosing these contour points and calculates a radius of the minimal circle. The radius of the minimal circle can represent the contour size of the hand object. In one embodiment, the hand feature extracting module 240 also can merely extract several points that belong to the contours of the hand object in the hand image, rather than extract all the contour points. This can reduce the amount of computation.

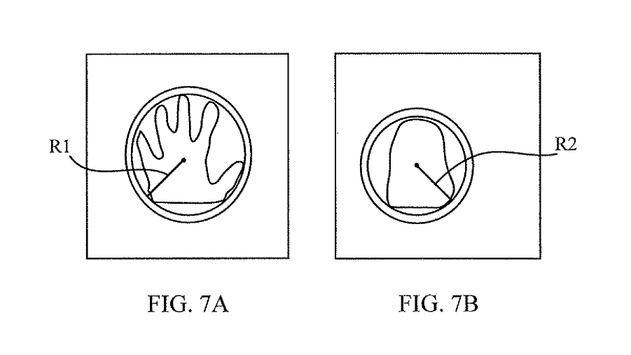

STEP S28: The gesture recognition module 250 receives the radius of the minimal circle transmitted from the hand feature extracting module 240 and then calculates a variation of the radius of the minimal circle. The gesture recognition module 250 also can directly receive the radius variation of the minimal circle calculated by the hand feature extracting module 240 in STEP S26. The gesture module 250 compares the radius variation of the minimal circle with a positive threshold and a negative threshold. The absolute value of the positive threshold can be identical to the absolute value of the negative threshold. When the radius variation of the minimal circle is greater than the positive threshold, this means that the user's hand is changed from a close gesture to an open gesture and this can represent a releasing operation of the mouser. When the radius variation of the minimal circle is smaller than the negative threshold, this means that the user's hand is changed from the open gesture to the close gesture and this can represent a pressing operation of the mouser. In another embodiment, the gesture recognition module 250 also can simulate the mouse operation by comparing the radius of the minimal circle with a threshold. For example, when the radius of the minimal circle is greater than the threshold, this means that the user's hand is open and this can represent the releasing operation of the mouse. When the radius of the minimal circle is smaller than the threshold, this means that the user's hand is in a close gesture and this can represent the pressing operation of the mouse. When the user's hand is changed from the open gesture to the close gesture and then opens again, this can represent a click event of the mouse. As shown in FIG. 7A and FIG. 7B, the radius of the minimal circles enclosing the hand object in the hand image are represented by R1 and R2 when the user's hand is respectively in an open gesture and a close gesture. The radius R1 of the minimal circle enclosing an open hand is greater than the radius R2 of the minimal circle enclosing a closed hand. That is, this can be utilized to represent the contour changes of the user's hand.

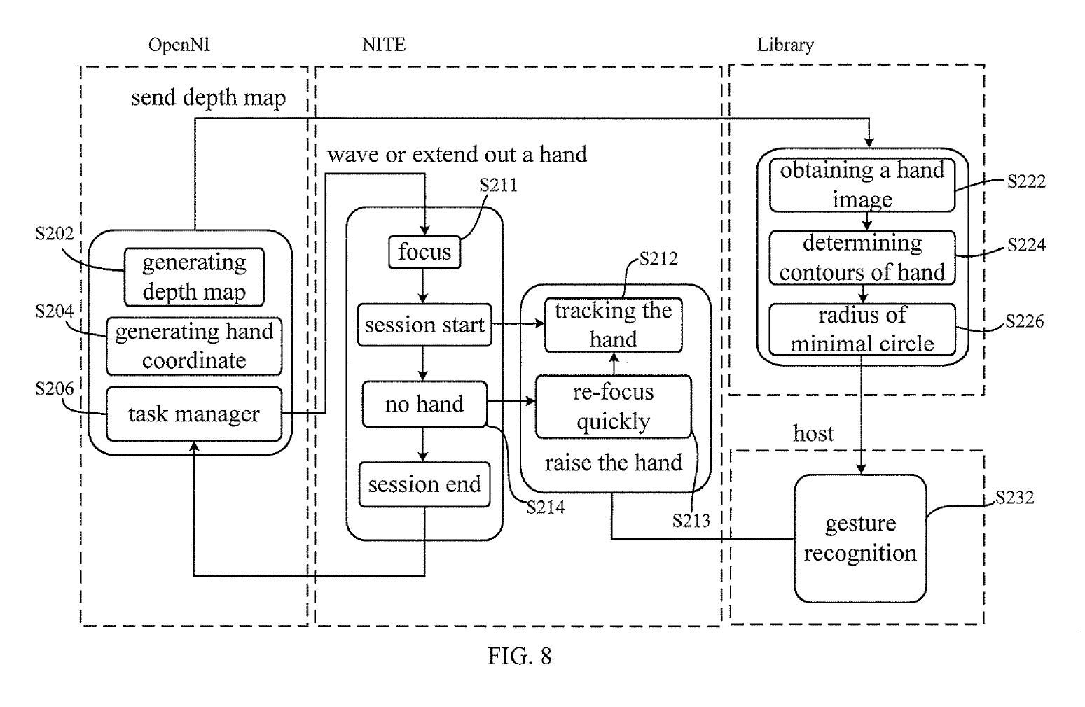

FIG. 8 is a flow chart showing specific work processes corresponding to the second embodiment of the present invention. The hardware arrangement and parts of work processes in FIG. 8 are the same as those in FIG. 7. However, STEP S224 and STEP S226 utilize approaches that are different from STEP S124 and STEP S126 to describe the contours of the hand object in the hand image, and STEP 232 utilizes a parameter that is different from STEP S132 to recognize gestures. STEP S202, STEP S204, STEP S206, STEP S211, STEP S212, STEP S213, STEP S214, and STEP S222 in FIG. 8 are similar to STEP S102, STEP S104, STEP S106, STEP S111, STEP S112, STEP S113, STEP S114, and STEP S122 in FIG. 8. The descriptions of these steps are omitted herein for simplicity and clarity. STEP S224, STEP S226, and STEP S232 in FIG. 8 will be described below.

In STEP S224, it can utilize cvFindContours( ) provided in Open Source Computer Vision Library (OpenCV) to determine contour points that belong to the hand object in the hand image. Next, in STEP S226, the coordinates of the contour points determined by STEP 224 are taken as an input parameter of minEnclsingcircle( ) provided in OpenCV. A minimal circle enclosing the contours points of the hand object and a radius of the minimal circle are calculated by utilizing minEnclsingcircle( ). The radius of the minimal circle can represent the contour size of the hand object. By determining the radius of the minimal circle or a variation of the radius, the self-developed application in the host can determine whether the user's hand is in an open gesture or a close gesture such that the click event of the mouse can be simulated (STEP S232).

In conventional skills, the pressing operation and the releasing operation of the mouse are simulated by gestures that are made when a user pushes his/her hand ahead and retracts backward the hand. This easily causes a shift of the hand coordinate when simulating a double click of the mouse. This is because the user's hand has to quickly move forward and retract backward for twice. The motion of the user's elbow will change the hand coordinate. It is quite inconvenient for the user when utilizing the aforesaid approach and the accuracy of click performance is bad. The present invention utilizes an open gesture and a close gesture made by the user's hand to simulate the pressing operation and the releasing operation of the mouse. Since opening and closing the hand is simpler than moving the hand forward and retracting it backward, the present invention is more convenient and the hand coordinate is more unlikely to shift or change when simulating the click operation of the mouse, especially the double click. Therefore, the present invention can solve the problem of a hand coordinate that is shifting when simulating the click operation of the mouse in the conventional skills.

In another aspect, a 3D touch system can be realized by the motion sensing input device such as Kinect and its application programming interface. The distance information of the user's hand can be obtained through the depth maps generated by Kinect so it is realizable to develop a 3D application with a 3D display on this 3D touch system. Furthermore, multi-touches on an operation system can be realized because the middleware “NITE” provides multi-hands tracking. Therefore, the gesture recognition system and method of the present invention is applicable to the aforesaid 3D touch system with the 3D display.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A gesture recognition method, for recognizing a hand gesture made by a user in the front of an electronic device to simulate an operation of a mouse, the method comprising steps of:
capturing an image including the user;
determining a hand coordinate of the user;
processing the image including the user to obtain a hand image of the user's hand;
calculating a point coordinate of a point, which belongs to the user's hand in the hand image and is located farthest from the hand coordinate; and
simulating a click event of the mouse according to a distance between the point coordinate and the hand coordinate.

2. The gesture recognition method according to claim 1, wherein in the step of determining the hand coordinate of the user, the hand coordinate is determined by computing image changes occurred when the user moves his/her hand.

3. The gesture recognition method according to claim 1, wherein the step of capturing the image including the user further comprises obtaining a depth map corresponding to the image including the user.

4. The gesture recognition method according to claim 3, wherein the step of processing the image including the user to obtain the hand image of the user comprises sub-steps of:
removing a part of the image including the user, of which a depth value of the depth map is greater than a predetermined number, to obtain a remaining image; and
defining a predetermined region on a basis of the hand coordinate for serving as the hand image by processing the remaining image.

5. The gesture recognition method according to claim 1, wherein a releasing operation of the mouse is represented by a situation when the distance between the point coordinate and the hand coordinate is greater than a threshold, and a pressing operation of the mouse is represented by a situation when the distance between the point coordinate and the hand coordinate is smaller than the threshold.

6. A gesture recognition method, for recognizing a hand gesture made by a user in the front of an electronic device to simulate an operation of a mouse, the method comprising steps of
capturing an image including the user;
determining a hand coordinate of the user;
processing the image including the user to obtain a hand image of the user's hand;
determining a minimal circle that encloses a hand object in the hand image and obtaining a parameter for describing the minimal circle; and
simulating a click event of the mouse according to the parameter describing the minimal circle.

7. The gesture recognition method according to claim 6, wherein in the step of determining the hand coordinate of the user, the hand coordinate is determined by computing image changes occurred when the user moves his/her hand.

8. The gesture recognition method according to claim 6, wherein the step of capturing the image including the user further comprises obtaining a depth map corresponding to the image including the user.

9. The gesture recognition method according to claim 8, wherein the step of processing the image including the user to obtain the hand image of the user comprises sub-steps of:
removing a part of the image including the user, of which a depth value of the depth map is greater than a predetermined number, to obtain a remaining image; and
defining a predetermined region on a basis of the hand coordinate for serving as the hand image by processing the remaining image.

10. The gesture recognition method according to claim 6, wherein the parameter describing the minimal circle is a radius, a releasing operation of the mouse is represented by a situation when a radius variation of the minimal circle is greater than a positive threshold, and a pressing operation of the mouse is represented by a situation when the radius variation of the minimal circle is smaller than a negative threshold.

11. A gesture recognition system, which is coupled to an electronic device, for recognizing a hand gesture made by a user in the front of the electronic device to simulate an operation of a mouse, the system comprising:
an image capturing module, for capturing an image including the user;
a hand tracking module, for determining a hand coordinate of the user by computing image changes occurred when the user moves his/her hand;
a hand image processing module receiving the image including the user captured by the image capturing module, for processing the image including the user to obtain a hand image of the user's hand;
a hand feature extracting module receiving the hand image from the hand image processing module, for obtaining a parameter related to describe contours of a hand object in the hand image; and
a gesture recognition module, for simulating a click event of the mouse according to a variation of the parameter.

12. The gesture recognition system according to claim 11, wherein the image capturing module further obtains a depth map corresponding to the image including the user, and the hand image processing module obtains the hand image by removing a part of the image including the user, of which a depth value of the depth map is greater than a predetermined number, to obtain a remaining image, and defining a predetermined region on a basis of the hand coordinate by processing the remaining image.

13. The gesture recognition system according to claim 11, wherein the parameter describing the contours of the hand object is a point coordinate of a point, which belongs to the user's hand in the hand image and is located farthest from the hand coordinate, and the gesture recognition module simulates the click event of the mouse by determining a distance variation between the point coordinate and the hand coordinate.

14. The gesture recognition system according to claim 11, wherein the parameter describing the contours of the hand object is a radius of a minimal circle enclosing the hand object in the hand image, and the gesture recognition module simulates the click event of the mouse by determining a radius variation of the minimal circle.
